(19) United States
(12) Patent Application Publication
(10) Pub. No.: US 2021/0178499 A1
(43) Pub. Date: Jun. 17, 2021

(54) METHOD FOR MACHINING TOOTHINGS, AS WELL AS TOOTHING MACHINE AND CONTROL PROGRAM FOR SAME

(71) Applicant: GLEASON-PFAUTER MASCHINENFABRIK GMBH, Ludwigsburg (DE)

(72) Inventors: Edgar Weppelmann, Asperg (DE); Jürgen Kreschel, Hemmingen (DE)

(21) Appl. No.: 16/770,435

(22) PCT Filed: Nov. 20, 2018
(86) PCT No.: PCT/EP2018/081969

§ 371 Date: Jun. 5, 2020

(30) Foreign Application Priority Data
Dec. 22, 2017 (DE) 10 2017 011 978.3

(51) Int. Cl. B23F 5/16; B23F 23/12

(52) U.S. Cl. CPC B23F 5/163; G05B 19/186; B23F 23/1225

(57) ABSTRACT

The invention relates to a method for machining toothings, which method uses a disk-shaped, toothed tool that is rotationally driven about its axis of rotation and has a geometrically defined cutting edge. The tool teeth are produced from a base material, are provided, at least on the tooth flanks, with a coating that improves wear resistance, and have machining surfaces facing an end face of the tool, said machining surfaces being re-ground from time to time when the tool is reconditioned, wherein after at least one regrinding, use of the tool is resumed and continued with regions of the machining surfaces formed along the cutting edges from the base material.

The invention relates to a method for machining toothings, for which a disk-shaped and toothed tool driven in rotation about its axis of rotation and having a geometrically defined cutting edge is used, the tool teeth of which are made of a base material and are provided with a coating that improves wear resistance at least on the tooth flanks, as well as having rake surfaces facing an end face of the tool, which surfaces are reground from time to time in the course of reconditioning the tool.

Such methods are well known, for example, through power skiving as described in EP 2 537 615 A1, to which reference is made with regard to the cutting conditions and kinematics of power skiving.

Power skiving is a rolling machining method that has come close to efficient hobbing in terms of machining speed, but offers advantages due to the tool shape and machining kinematics, such as the possibility of generally being able to machine internal teeth well.

For a longer durability of the skiving wheels used, their basic material, which can be hard metal (HM) or a Powder Metal High-Speed Steel (PM-HSS), for example, is provided with a coating that increases wear resistance, thus extending the period of use and the overall service life of the tool.

When machining workpieces, for example a large workpiece charge, the tool wears out, so that after a certain time a tool change is performed. In a typical use of an HSS tool, a tool change should be performed after 3 to 12 hours of machining, depending on the material being machined, in order to prevent a deterioration in the quality of the machined toothings or further damage to the tool. Carbide tools last comparatively much longer, about a factor of 2 to 3+ times as long.

If the wear limit intended for the respective machining has been reached, a new tool is clamped in the machining device, after which the machining can be continued, for example on a larger workpiece charge. However, the used tool can be reconditioned for further using as long as its final wear limit has not yet been reached. In the case of a prior art reconditioning, the wear is measured (the wear is usually measured at the head of the tool tooth, looking radially at the tool tooth head, as it is often greatest here, in the axial direction, i.e. towards the head flank), the rake surfaces are ground until the wear is no longer visible, if necessary with the addition of a safety margin, after which the tool is decoated and then recoated. The machine operator then receives the recoated tool, but with a lower height due to regrinding and, in the case of conical head flanks, also with a correspondingly smaller diameter, and takes these changes into account for further use of the tool.

The invention is based on the object of further developing a method of the type mentioned above, in particular with a view to improved integration into an overall procedure.

In procedural terms, this problem is solved by the invention in that the use of the tool is resumed and continued after at least one regrinding with regions of the rake surfaces formed in any case along the cutting edges from the base material.

The invention is based on the recognition that the directly caused disadvantage of a reduced overall service life on the one hand and reduced period of use until the next regrinding on the other hand, since the rake surfaces can be compensated or even outweighed by advantages in the overall procedure when machining is resumed at least along the cutting edges, preferably having no coating at all, and therefore wear more quickly. Because the tool is no longer recoated after regrinding, the tool can be used again more quickly, in particular on the same toothing machine, so that the number of additional tools to be kept by the machine operator can be reduced. In addition, due to the lower influence on the tool only by regrinding the rake surface regions or rake surfaces, the basic prerequisite is created to perform measures for any necessary machine-sided corrections for quality assurance of the machined toothings after resumed machining with less time exposure, which can at least partially compensate for a loss of machine-sided machining time, which, in any case, can occur during the time of resharpening.

The tool can preferably be a skiving wheel for power skiving or a skiving wheel for hard skiving of toothings, but also a cutter wheel for gear shaping of toothing wheels. The base material could be one of the materials already mentioned above, hard metal (HM) or a powder metal high-speed steel (PM-HSS), but is not limited to this. The coating that increases wear resistance could be AlCrN, for example, or any other coating commonly used by persons skilled in the art, such as TiN. The machining method can be used for both internally and externally toothed workpieces (for the latter especially suitable in case of existing interfering contours).

For the first use after tool manufacture, the tooth flanks of the tool teeth are in any case coated with this coating, preferably at this time, i.e. with the new tool, the rake surfaces are also coated.

When regrinding, it is preferable to regrind the rake surfaces as a whole, which simplifies the regrinding procedure. In any case, regrinding is carried out from time to time in the region of the cutting edges, and in the case of the skiving wheel or cutter wheel in the rake surface region of the tooth edges.

When regrinding, it is advisable to grind off an amount of material so that the wear marks on all teeth are completely removed afterwards. A rule of thumb for current prior art methods is that PM-HSS or HM-tools are used until the wear mark width is between 0.2 to 0.3 mm or 0.1 to 0.2 mm—or until an unacceptable deterioration in the quality of the machined workpieces is determined—whichever occurs first.

In a preferred method layout it is provided that regrinding is carried out comparatively more frequently. For carbide tools, for example, regrinding is preferably carried out before or when reaching a wear mark width of 0.08 mm, further preferably of 0.065 mm, in particular from 0.05 mm. For PM-HSS tools, it is planned to carry out wear mark widths as low as 1.6 mm, further preferably as low as 0.13 mm, in particular as low as 0.1 mm. This is preferable if the decision for regrinding is based on the wear marks, but it can also be provided that regrinding should be arranged if a specified workpiece quality is no longer achieved beforehand. Since there is no recoating of the tool during at least one regrinding of the tool, preferably during a plurality of regrinding procedures, especially during all regrinding procedures, the loss of time accepted by the more frequent regrinding is tolerable.

This, compared to the prior art, in which the tool is waited as long as possible before being resharpened, which is comparatively much earlier, is also regarded by the invention as an aspect independent of any question of coating or non-coating and is accordingly disclosed as being independent and capable of being protected independently. The invention thus reveals as independently protectable a method for machining of toothings, to which a disk-shaped and toothed tool with a geometrically defined cutting edge is used, which is driven rotationally about its axis of rotation and whose tool teeth have rake surfaces facing an end face of the tool, which surfaces are reground from time to time, the use of the tool being resumed and continued after regrinding, wherein the method is substantially characterized in that resharpening is carried out already on or before reaching a wear mark width of 1.6 mm, more preferably 0.13 mm, in particular 0.1 mm, this in particular for PM-HSS tools, and more preferably already before or on reaching a wear mark width of 0.08 mm, more preferably 0.065 mm, in particular already from 0.05 mm, in particular for HM-tools. This aspect can be combined with the other aspects of the invention mentioned previously and subsequently. Thus, it was also recognized within the scope of the invention that, in particular in the machining method of hard skiving, a tool displacement during machining can occur due to already low wear on the tool and in the course of this, unwanted deviations from the desired machining can occur. This can be countered by more frequent resharpening. For this purpose, it may be sufficient to resharpen only a small amount, for example by delivering only a small amount.

However, it is also provided within the scope of the invention that the tool is recoated one or more times during its overall service life, as was previously the case in the prior art, and also partially or completely recoated in the course of reconditioning. This is particularly preferred if tooth flanks and/or tip flank are also reground during a regrinding procedure.

In a particularly preferred embodiment, it is provided that the continued use of the tool is carried out on the same toothing machine as the use before regrinding. Apart from changes to the machine axis adjustment that have become required due to regrinding, the machine axis adjustment already set up for this tool can therefore be used. Then a new machine does not need to be set up for this tool.

In a particularly preferred configuration, it is intended that a machine control for continued use should in particular automatically receive information on the depth of material removal during resharpening. This means that the key information for necessary changes to the machine axis adjustment (e.g. due to changes in height or diameter of the tool) is already available in the machine control.

In this context, a layout is possible in which continued machining is carried out without intermediate measurement of a first reworked gearing after resumption. Due to the lower influence of the tool during reconditioning compared to the prior art due to the not performed decoating/recoating procedures, the continued use already with the correct machine axis adjustment leads to acceptable machining qualities.

A re-measuring of the tool after regrinding is also no longer absolutely necessary and can be purposefully omitted, so that there is potential for relative additional time savings.

For the place of regrinding several variants are conceivable. Thus, the tool could in principle be located outside the machining position and clamping, even spatially completely away from the toothing machine on which the tool was working.

In a possible variant, the tool is exchanged via a tool changer before regrinding and the regrinding is carried out on a regrinding station coupled in particular via the tool changer or in the tool changer. A variant is also provided for in which the tool remains in the tool clamping of the previous use, but the regrinding is not carried out in the same machining area of the use, but in an adjacent regrinding area, for example by swiveling or moving the tool head or a main column supporting it. Then there is a wide range of possibilities for the realization of a grinding stroke, not only the axes of the tool head but also separate axes, also in combination; diagonal axes are also conceivable.

A preferred variant is one in which regrinding is carried out in the tool clamping of a toothing machine or an extended machining center on which the previous and/or continued use is carried out. In particular, the regrinding can be carried out in the machining area of the toothing machining, wherein the machine axes already available for the tool can of course be used for regrinding and are preferably also used as positioning axes or as axes controlled during regrinding. It can also be provided that the machining tool remains clamped on the same toothing machine until it reaches the end of its overall service life or until the kind of workpiece for which it is designed (workpiece charge) is changed.

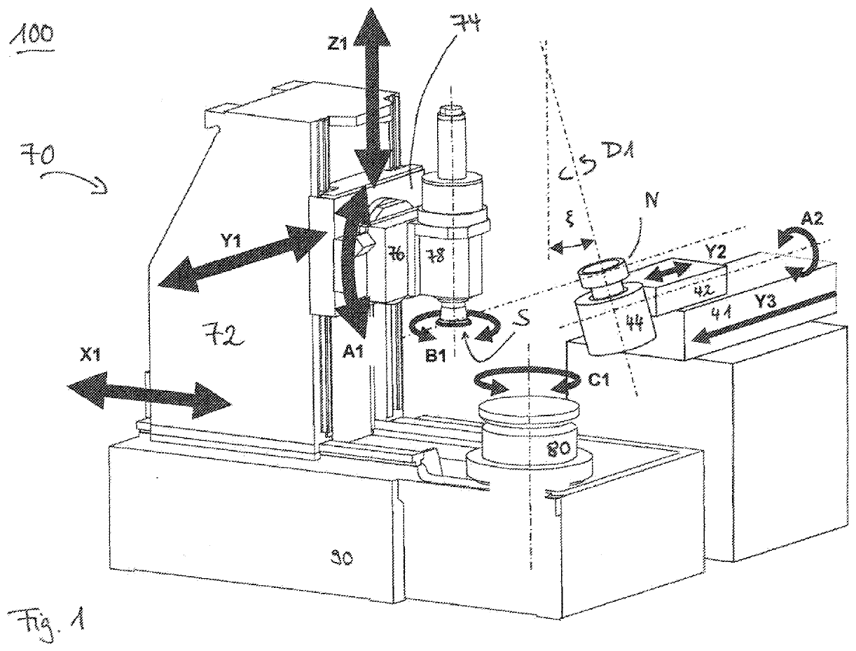

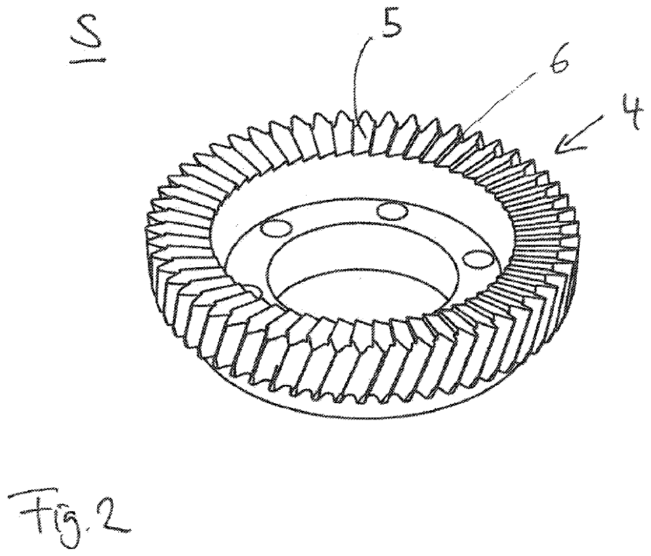

The axis movements required for positioning and possibly for a grinding stroke of the regrinding tool can also be performed by movement axes that actively move the regrinding tool. The concrete realization of the grinding stroke will preferably depend on the available space conditions and also on the form of the machining tool used (e.g. for step cut), as well as on the type of the regrinding tool (cup wheel or grinding disk/grinding body of rotation with cylindrical or conical grinding lateral surface). The grinding stroke can, but does not have to be horizontal. It is conceivable, for example, to regrind a tool with a step cut (see FIG. 2) with the lateral surface of a cylindrical or conical grinding tool. In this case, the stroke movement could be carried out by an obliquely set tangential axis (Y1 in FIG. 1). It is also conceivable to superimpose a movement axis for the grinding stroke movement on another axis, such as that for a traversing movement of the machining tool (axis Z1 in FIG. 1) parallel to the axis of rotation of the machined workpiece.

In a preferred variant it is provided that the regrinding tool is fed from a direction tangential to a radial infeed movement of the toothing machining. This constellation leads to a favorable utilization of space and room conditions. This position feed axis could also be used to realize the grinding stroke. However, a variant is also preferred in which a movement axis of the machining tool is used for the grinding stroke.

Depending on the layout of the tool to be resharpened, variants of continuous resharpening are conceivable, but an intermittent way of working is also considered, in which the rake surfaces of the individual teeth are reground one after the other and between two such machinings the tool is rotated about its axis of rotation. In these intermittent methods, it is preferred to deviate from twisting to the next rake surface, and the rake surfaces are ground in a sequence in which signs of wear of the regrinding tool or changes in temperature do not have an increasing effect in the direction of the tool circumference, but are distributed over the tool circumference.

Depending on the layout of the regrinding tool, it can be provided that, if necessary, no grinding stroke movement is required, especially if the grinding surface fully covers the rake surface during the machining engagement. In other embodiments, which are preferred, it is provided that the rake surface is reground under execution of a grinding stroke movement, wherein the latter can be particularly horizontal.

In a possible method layout, a swivel angle of the tool axis orientation remains unchanged between use during machining and regrinding. In this way, any loss of accuracy by changing this tool axis orientation over a provided swivel angle is avoided.

In a preferred embodiment, the tool has a non-zero head rake angle and a swivel angle for tool axis orientation is set to the head rake angle for regrinding. This enables simple regrinding movements. However, as explained below, a coordination of an offset of the grinding position with superimposed movements instead of a swivel angle adjustment is also possible.

In one possible configuration, before regrinding, a probing of the tool is performed with the regrinding tool, especially semi-automatically or automatically. This is used for the exact relative positioning of the regrinding tool and the tool to be reground in height direction (axial direction) and/or with regard to the rotational position of the teeth or tooth gaps of the tool.

As already mentioned above, the machine control preferably contains information about the regrinding procedure. In a particularly preferred configuration, it is provided that the machine controller should independently calculate (and then adapt the machine axis adjustments accordingly) the adaptation of the machine axis adjustments required for continued use due to a change in the height and/or diameter of the tool resulting from regrinding compared to the previous machining. For this purpose, the machine control has the usual design data of the tool (including height, diameter, taper).

In a preferred variant, the tool has a step cut. Good results are also achieved for this tool layout, which makes it impossible to design a plan ship over several teeth.

This regrinding of a tool with step cut (see FIG. 2) could be carried out with a cup wheel, for example. However, an equally preferred variant is also provided for the regrinding machining engagement to be carried out with a lateral surface of a cylindrical or conical regrinding tool. This aspect is regarded as advantageous in connection with the regrinding of the machining tool in its clamped state in the tool clamping of the machining, also independently of whether the machining tools are coated or not, and is correspondingly disclosed as independent and worthy of protection.

However, it is also intended to work with tools in which the portions of the rake surfaces belonging to a circumferential circle around the tool axis are at the same axial height with respect to the axis of rotation of the tool, and which therefore do not have a step cut.

In a preferred embodiment it is provided that the normal vector to the grinding surface of the regrinding tool runs predominantly radially to the axis of rotation of the regrinding tool. In particular, rotationally symmetric grinding wheels and grinding disks with the grinding surface lying on the lateral surface of the regrinding tool are considered here. This can be designed cylindrically or conically.

In another, equally preferred embodiment, regrinding tools are also considered, where the normal vector to the grinding surface is predominantly parallel to the axis of rotation of the regrinding tool. Suitable tools for this purpose are in particular cup-wheel-type tools, including moon-disk-type tools.

In a preferred configuration, at least one machine axis actively moving the regrinding tool is used for relative positioning of the regrinding tool to the tool to be reground.

Such an arrangement in combination with regrinding taking place in the tool clamping of the machining insert is considered to be advantageous, also independently of the question of tool coating.

The invention thus also reveals as independently protectable a method for machining toothings, to which a disc-shaped and toothed tool with a geometrically defined cutting edge is used, which is driven rotationally about its axis of rotation and whose tool teeth have rake surfaces facing an end face of the tool, which are re-ground from time to time within the scope of reconditioning the tool, and which is essentially characterized in that the regrinding is carried out in the tool clamping of a toothing machine on which the prior and/or continued use of this tool takes place after the regrinding, wherein at least one machine axis actively moving the regrinding tool is used for the relative positioning of the regrinding tool to the tool to be reground.

However, it is preferably additionally or alternatively provided that at least one machine axis actively moving the tool to be reground is used for relative positioning between the regrinding tool and the tool.

In a preferred embodiment, it is provided that the rotary movements of the tool and the regrinding tool are coordinated with each other in order to generate predominantly radially running grinding grooves on the tool. The predominantly radially running grinding grooves are considered advantageous compared to tangential or random orientation of the grinding grooves. In this context, it is preferable to ensure that the predominant directional components of the grinding movement and grinding stroke movement in the region of grinding engagement coincide.

Furthermore, it can be provided that the tool to be reground and the regrinding tool overlap in two non-contiguous regions when viewed in projection on the tool disk plane, which are separated in particular by a separating region overlapping a plurality of tool teeth (i.e. the regions are not separated from each other only because there are tooth gaps). This variant is particularly preferred for tools not ground in step cut in the non-intermittent regrinding method. It allows favorable grinding direction conditions.

In particular, however, it may be provided to grind in one region and to dispense with a sliding contact in the other region of non-contiguous regions. This can be achieved, for example, if the grinding plane of the regrinding tool is brought out of parallelism with the face plane of the tool by means of a swivel axis. This can be extremely small, for example expressed in degrees, corresponding to a swivel angle of 0.01° to 0.03°, so that the deviation from parallelism in the region with sliding contact is only minimal.

The aspects of the grinding directions, some of which have already been partly explained above, are also considered to be advantageous by the invention independently of any question of coating. Correspondingly, the invention reveals as independently and independently protectable a method for the machining toothings, to which a disk-shaped and toothed tool, driven rotationally about its axis of rotation and having a geometrically defined cutting edge, in particular a tool toothed in step cut, is used, the tool teeth of which have rake surfaces facing the end face of the tool, which is reground from time to time within the scope of reconditioning the tool, and which is substantially characterized in that in the grinding contact region, as seen in a projection onto the disk plane of the tool, the predominant directional component of a tangent of the rotatory grinding movement of the regrinding tool used for regrinding runs parallel to the radial direction with respect to the axis of rotation of the reground tool.

This independent layout can also be combined with the other aspects mentioned above.

The invention is also protected in the form of a control program which, when executed on a machine control of the toothing machine, controls the toothing machine to perform a method according to one of the aspects mentioned above.

Furthermore, the invention is protected by a toothing machine with a workpiece spindle for the rotatably drivable bearing of a workpiece carrying a toothing, a tool spindle for the rotatably drivable bearing of a disk-shaped and toothed tool with a geometrically defined cutting edge and with machine axes for the relative positioning of tool and workpiece, as well as a machine control for the control of the toothing machining executed with the tool, which is substantially characterized in that the machine control has a control program as aforesaid and/or movement means which, when actuated, brings a regrinding tool for regrinding the rake surfaces of the tool teeth into grinding engagement with the tool.

It is particularly preferably provided, that the movement means have at least one machine axis which can changeably adjust the location or orientation of an axis of rotation of the regrinding tool.

Also planned are the pick-up solutions known to the person skilled in the art for an implementation of the regrinding solutions according to the invention. It can be provided that a pick-up spindle carrying the regrinding tool can be moved into the position in which a workpiece spindle designed as a pick-up spindle carries the workpiece during the machining procedure. However, solutions are also being considered in which a relative movement for transferring the tool from one machining position to a resharpening position and vice versa (i.e., between the two spindles) is achieved by an active movement of the tool head.

Further features, details and advantages of the invention can be found in the following description with reference to the accompanying drawings, in which

FIG. 1 shows a toothing machine with an integrated regrinding arrangement,

FIG. 2 shows a tool to be reground in the form of a skiving wheel in the step cut,

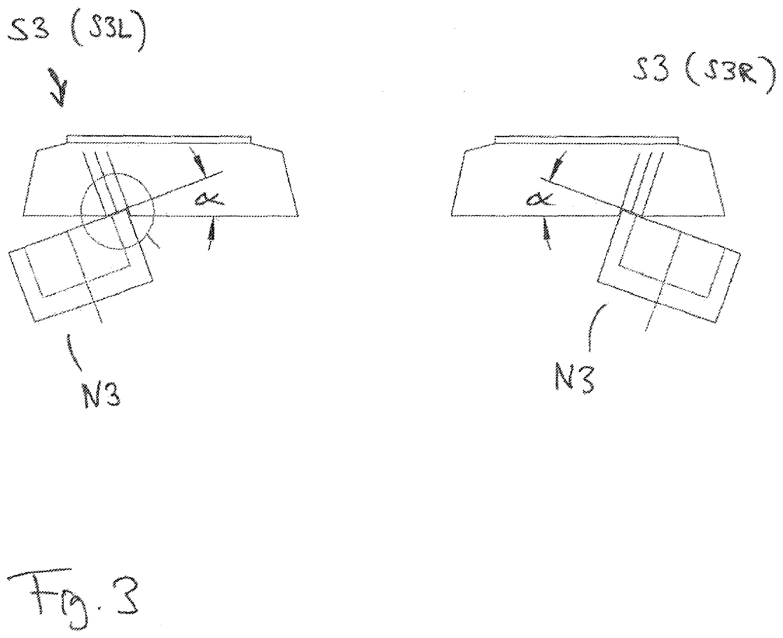

FIG. 3 shows schematically a regrinding engagement matching a step cut,

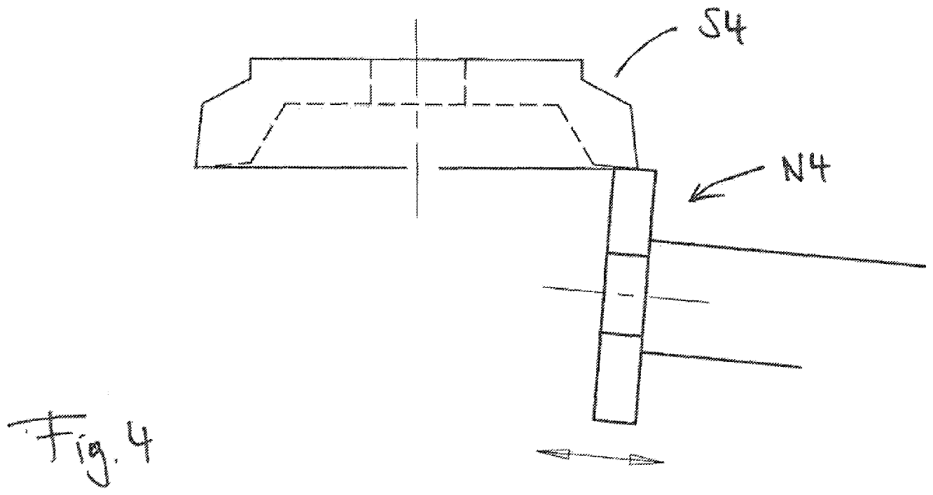

FIG. 4 shows schematically an engagement suitable for a non-zero head rake angle,

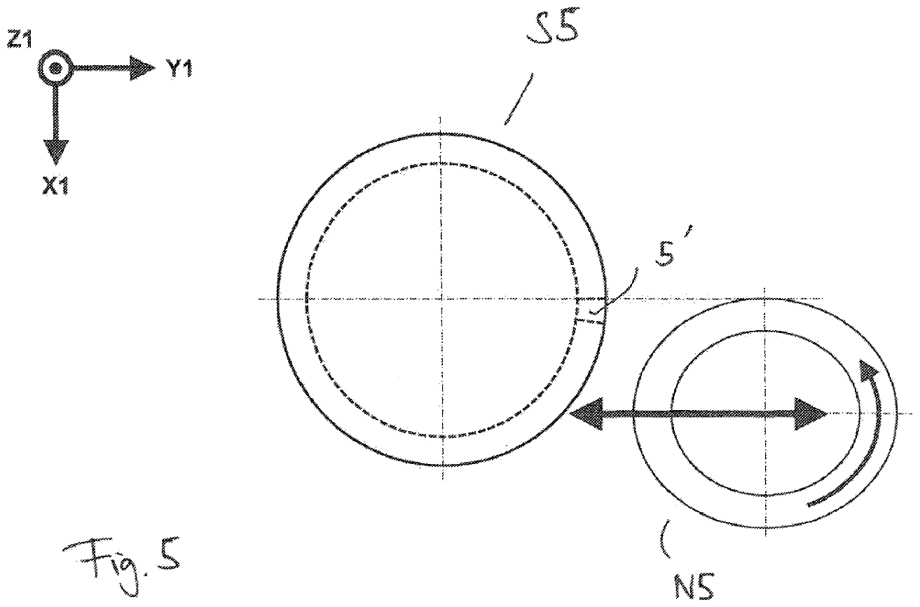

FIG. 5 shows positioning arrangements and grinding stroke possibilities, still outside of engagement,

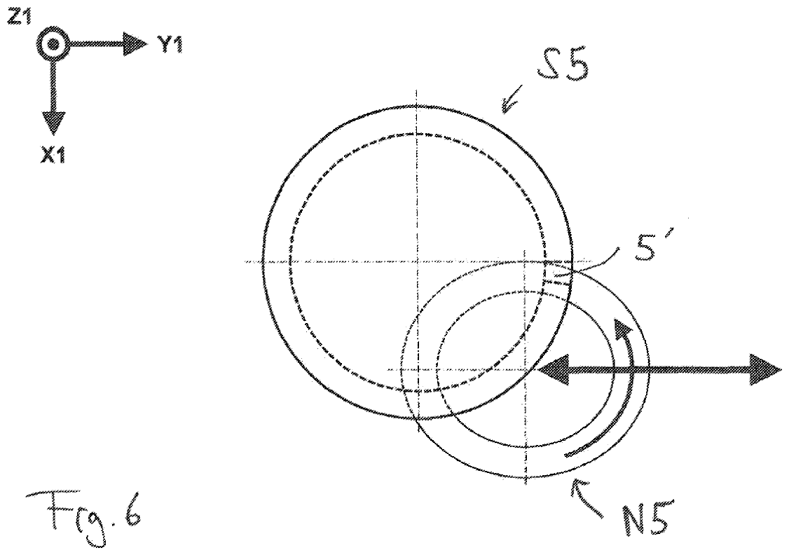

FIG. 6 represents the variant represented in FIG. 5 in engagement,

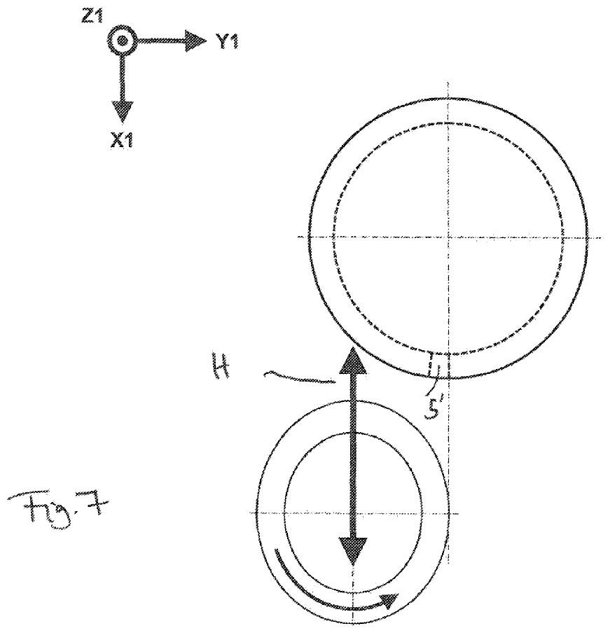

FIG. 7 shows an alternative arrangement possibility to FIG. 5,

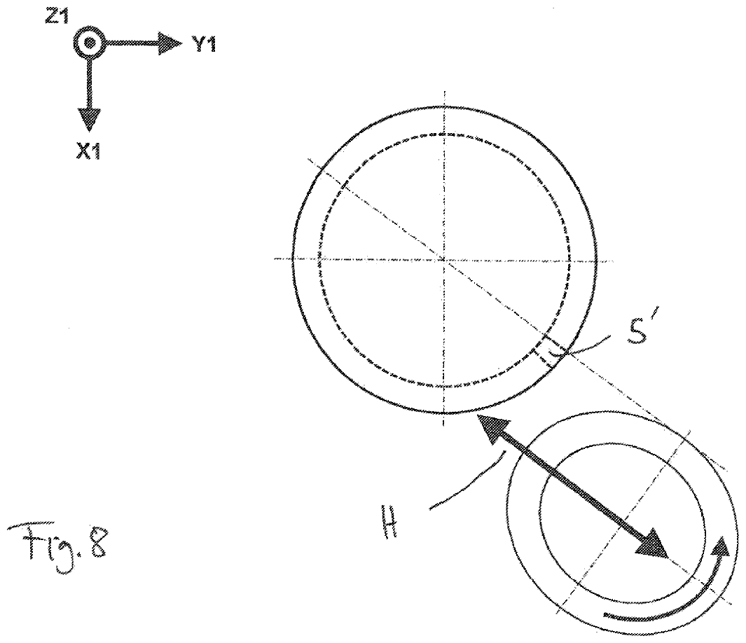

FIG. 8 shows another different arrangement possibility,

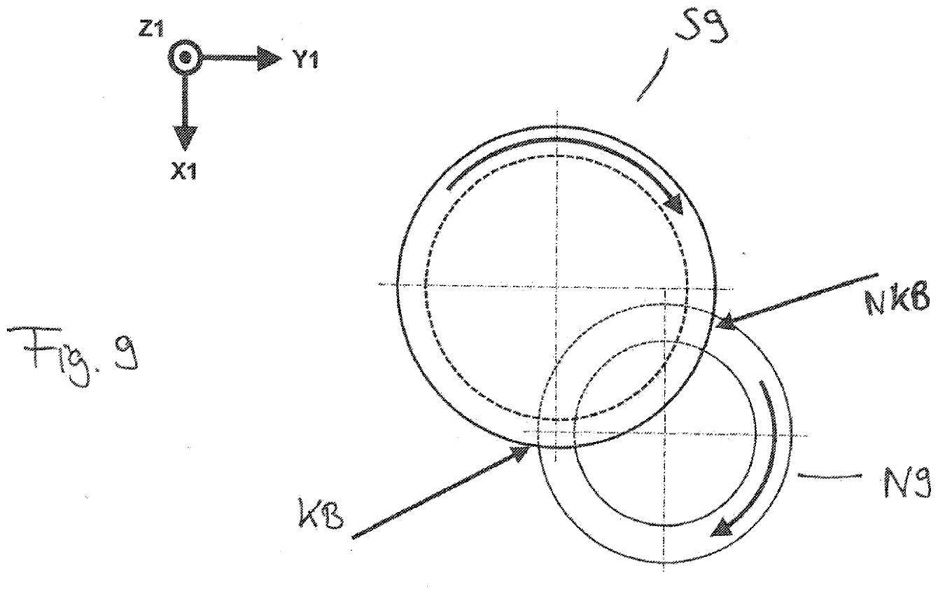

FIG. 9 shows a schematic arrangement for machining without tool step cut, and

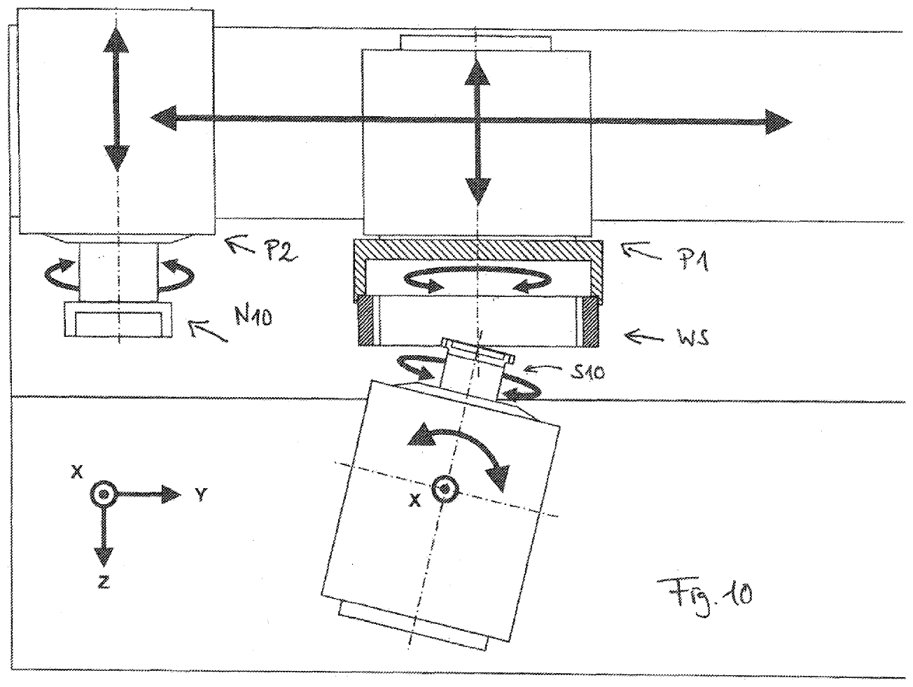

FIG. 10 represents an arrangement possibility in a variant of a pick-up solution.

The tool machine shown in FIG. 1 is a machine 100 designed for a skiving machining with one skiving wheel S. On the workpiece side, the machine 100 has a tool table 80 rotatably driven in the machine bed 90, in which a workpiece to be machined not shown in FIG. 1, for example with an internal toothing to be machined, can be rotatably clamped around the workpiece sided machine axis of rotation C1.

On the tool side, the machine 100 has a linear machine axis X1 for a positioning movement of the tool radially with respect to the workpiece, an axis Z1 for a movement of the tool along the axial direction of the table axis C1, and an axis Y1 for a tangential relative movement between tool and workpiece. These linear axes X1, Z1 are perpendicular to each other and are realized by a slide arrangement 70, where a linear slide 72 for the X1 movement carries a vertical slide 74 for the Z1 movement. The tool head 78 carrying the tool S, which in this embodiment also carries a CNC drive as direct drive for tool rotation with axis of rotation B1, is movable with a linear slide 76 for the tangential movement Y1. However, the tangential slide 76 is rotatably mounted on the vertical slide 74 with swivel axis A1, so that its slide movement is horizontal only in the setting shown in FIG. 1, and is otherwise inclined relative to the Z1 axis by the adjusted swivel angle A1.

In addition, the machine 100 has a further movement system with which a regrinding tool N can be brought into regrinding machining engagement with the skiving wheel S clamped in the tool clamping of the tool head 78, wherein the linear axes and axes of rotation on the tool side can also be used for production of the regrinding engagement. In the represented exemplary embodiment, the regrinding tool N, which is in this exemplary embodiment in the form of a cup wheel, is movable in a tangential direction Y orthogonal to the X1-Z1 plane. It can thus be introduced laterally into the machining region with respect to the radial direction X1. This movability in Y-direction is realized by a double slide 41, 42, of which the lower slide 41 is intended for positioning with axis Y3, while the upper slide 42 is intended for the grinding stroke movement. In addition, a regrinding spindle 44, which carries the regrinding tool N and drives rotationally about the axis D1, is pivotally arranged in a plane orthogonal to the Y direction (the swivel axis is marked A2), so that an angle between the axial direction of the axis of rotation D1 and the axis Z1 (C1) can be adjusted in a plane parallel to the X1-Z1 plane.

Also conceivable are variants in which the Y1 axis (possibly in combination with Z1) of the tool head 78 is used for the grinding stroke movement and, if necessary, axes on the grinding head such as Y2 are then saved. It is also conceivable to have an additional axis X2 of the grinding head parallel to the X1 direction.

If the skiving wheel S with its coated teeth has now reached a certain wear due to the machining of the workpieces, the rake surfaces of the skiving wheel S are reground.

This is described in the following for a skiving wheel S, which is ground in step cut (see also FIG. 2) and has a non-zero head rake angle. In this case the regrinding tool N is swiveled to the step cutting angle of the skiving wheel S with swivel axis A2. The swivel axis A1 of the skiving wheel S is swiveled to the head rake angle of the skiving wheel S. In this adjustment, a center line of rake surface 5 to be reground (in indexing method) is horizontal in the 90° position with respect to the radial axis X1, facing the face of the regrinding tool N. In the grinding stroke movement (axis Y2, see also FIGS. 5, 6)), the machining region then moves along the rake surface 5 during the grinding stroke, wherein the orientation of the grinding region of the cup wheel N coincides with the orientation of the rake surface 5, so that the rake surface 5 can be ground off by an intended removal. It is understood that the Z1 axis of the skiving wheel S can be used for the height adjustment of the machining engagement and the infeed, while the XY machine axes are used for positioning. In addition to the rake surfaces 5, when using a tool S as shown in FIG. 2, its side-faces 6 can also be reground.

Due to the lateral feed of the regrinding tool N with respect to the radial axis X1, competing space requirements on the machine side are avoided. In addition, due to the parallelism of grinding stroke and feed direction of the tracking tool, vibrations during regrinding are largely avoided. When all rake surfaces 5 have been reground in this way, one after the other in indexing machining, the regrinding tool N is retracted and the toothing machining by the skiving wheel S can be resumed and continued.

The changes in the machine axis adjustments required for further machining due to the changed skiving wheel shape resulting from regrinding (smaller diameter, smaller height) are automatically calculated by the machine control. The machine control has the necessary information for this from the tool layout stored in it and knowledge of the removal carried out during resharpening about the axis positions of the machine axes used for this.

In alternative embodiments, however, the grinding stroke could also take place in the X1 machine direction (see also FIG. 7), if, for example, regrinding is carried out on the face of the tool which is closest (0° position, e.g. for internal toothings) or furthest (180° position, e.g. for external toothings) to the main machine column (70). In this case it would be preferable to leave the swivel axis adjustment of the tool head 78 adjusted to the machining axis cross angle. For example, if the workpiece machining is that of internal toothings, where work is done in the zero° position, in the 180° position, you could adjust to twice the opposite axis cross angle to set the rake surface 5 horizontally. However, it is also conceivable not to change the axis cross angle in this way or to leave it in the position for machining. It could then be provided that the grinding head (44) is provided with a further swivel axis; it is also conceivable to use strongly conical lateral surfaces on a grinding disk not configured as a cup wheel. In the case without a head rake angle, radially horizontally running rake surfaces would then have to be reground; if a head rake angle is available, the regrinding contact could be maintained, for example, by an additional movement of the machine axis Z1. For this purpose, when using a cup wheel, axis A2 (FIG. 1) could be swiveled to the head rake angle; in this case, the swivel axis A2 of the regrinding head adjusts the same orientation of the surface to be ground in the machining engagement.

In this variant, it would be preferable to perform the regrinding on the face of tool S that is closest to the main machine column (slide arrangement 70) in order to avoid space competition with the workpiece table 80. This is particularly important when machining internal toothings, since in this case it is not necessary to swivel in via the swivel axis A1 of the tool head 78. In the case of an external toothing, regrinding would have to be performed in the 180° position if you do not want to swivel in via the swivel axis A1. In the 180° position, more favorable conditions of the available installation space are often present. Particularly if the skiving wheel S does not have a head rake angle, it can also be considered to draw the rotational movement of the regrinding tool N via the spindle carrying the workpieces during machining (in a constellation similar to FIG. 1 the machine table 80) and to perform the grinding stroke via the radial axis X1. This variant is also conceivable with a head angle unequal to zero by drawing on the radial axis X1 for the grinding stroke and by drawing on a coordinated offset of the engagement region (relative to the 0° position) with superimposed movements Y1 and Z1.

Via the existing machine axes of the arrangement represented in FIG. 1, on the one hand for the skiving wheel S and on the other hand for the resharpening tool N, superimposed variants can also be designed in which the grinding stroke is carried out in a diagonal direction (i.e. with X and Y directional components). In this case, the swivel angle (A1 axis) of the skiving wheel S is preferably adjusted to match the desired head rake angle in dependence on the grinding stroke direction and the angle adjusted for the regrinding tool N.

Depending on the dimensions of the regrinding tool N used, it is also possible to dispense with the realization of a grinding stroke completely, that is, if a rake surface 5 is already completely covered. The regrinding would then be a plunge-cut grinding.

For exact determination of the relative location between the skiving wheel S and the regrinding tool N, it is possible to touch the skiving wheel S with the regrinding tool N in the axial direction as well as in the circumferential direction, in order to establish the exact relative height position as well as relative angular location of the teeth of the tool S to the grinding tool N. This is particularly indicated after changing the machining tool S and/or regrinding tool N. This is because swiveling in of the grinding head 78 makes it possible to leave the tool S at the machining axis cross angle. However, the angular location of the tool teeth 4 may already be known due to the preceding machining and monitoring of machine axis B1. For contact detection, noise detection can be considered, as well as monitoring of the machine axes, for example, by means of a change in torque on the tool or workpiece spindle (B1/C1). Visual recognition methods such as sparking could also be used.

This type of probing is also preferred if the regrinding tool N itself has been subjected to a pulling procedure. It can run fully automatically, i.e. the machine 100 carries out the probing independently, or under rough prepositioning by an operator semi-automatically or alternatively software-guided, if the operator controls the probing via the machine control panel. A purely manual variant by probing through axis movements using hand control is also conceivable.

If, for example, skiving wheels are worked with, which do not have a step cut, a continuous method for regrinding can be used in addition to the intermittent method. If realized, for example, with a cup wheel as the regrinding tool, the skiving wheel would be swiveled in to an angle (A1) of 0°, i.e. adjusted for substantially horizontal rake surfaces or left in such an already adjusted adjustment. A continuous rotation of the skiving wheel is realized via axis B1. When using a cup wheel, a preferred layout (see FIG. 9) results in an overlap region in two non-contiguous regions of the skiving wheel. Here, it is preferred that a minimal deviation of parallelism between the grinding surfaces of the regrinding tool and the grinding surfaces of the skiving wheel ensures that only in one of the non-contiguous regions (KB) a grinding machining takes place, while in the other region (NKB) there is no contact due to this slight deviation (for example, the regrinding tool is ground in the order of a few hundredths of a degree, e.g. 0.01 to 0.03° deviating from zero, so that in the other overlap region NKB there is a lift-off between the regrinding tool and the skiving wheel and thus no contact occurs anymore). This small deviation in the parallelism of the two planes could also be achieved via the swivel axis (A1) of the skiving wheel. In this case it is again possible to effect the rotatory movement of the regrinding tool via the C1 workpiece spindle. Otherwise, the non-parallelism can also be adjusted via the swivel axis A2 of the regrinding tool.

If it is ensured in this way that regrinding is carried out in only one (KB) of the two overlap regions, substantially radial grinding grooves can be produced, which are considered to be advantageous.

In a concrete example (here: head rake angle zero) the cutting speed of the cup wheel could be 30 m/s, and at a rotational speed of 1/s revolutions of the skiving wheel with, for example, a skiving wheel diameter of 200 mm with a resulting skiving wheel circumferential speed of 0.63 m/s it could be achieved that the grinding grooves deviate only a few degrees from the radial direction (skiving wheel system with skiving wheel center), in the concrete calculation example even only by 1.2°. As already mentioned above, a swivel angle adjustment in the range of +−0.01 to 0.03° can be sufficient, depending on the diameter of the cup wheel. The grinding direction should preferably point towards the center of the reground tool.

If head rake angles of non-zero degrees are to be produced, the rake surfaces could also be ground in the form of calottes, but with a slightly curved surface in the radial direction. As an alternative to the above-mentioned matching, an additional swivel axis of the tool head 78, not shown in FIG. 1, could also be achieved to generate head rake angles unequal to zero degrees.

In principle, a comparatively flat cup could also be used as these cup wheels, or even a moon disk. In comparison to a full cylindrical disk, only a narrow region is used with a cup wheel, which is then correspondingly easier and more accurate to dress, which brings advantages in dressing the regrinding tool.

In principle, the generation of grinding grooves in a predominantly tangential direction is also conceivable, although this is less preferred to the variant with grinding grooves running predominantly in a radial direction. However, such a variant also allows regrinding with the lateral surfaces of grinding disks (the skiving wheel has no step cut for this purpose) over a plurality of teeth according to the continuous method. In this case, the A1 swivel axis for the skiving wheel can be adjusted to a corresponding angle to achieve a rake angle deviating from zero, the regrinding wheel is swiveled in to an angle of 90° (but not with the A2 axis, but with an additional swivel axis with which the axis of rotation D1 of the regrinding tool is swiveled in horizontally and parallel to the Y2 direction. A head rake angle unequal to zero can then be set via this axis or alternatively via the A1 axis), the Z1 axis is used for height adjustment and infeed, and the available linear axes orthogonal to the Z1 direction for mutual positioning.

FIG. 2 shows the shape of a skiving wheel S which could be used on the machine 100 represented in FIG. 1. The design of the tool teeth 4 formed in step cut can be clearly recognized with the rake surfaces 5 formed in step cut. The tool S shown in FIG. 2 also has a non-zero head rake angle 5, the rake surfaces are also inclined with respect to the radial direction. Due to the available machine axes shown in FIG. 1, for example, it is possible to adjust the orientation of the rake surfaces 5 to match the grinding region of a cup-shaped grinding disk, for example.

FIG. 3 clarifies the engagement situation when regrinding a cutting wheel S3 with a regrinding tool N3 in the form of a cup-shaped grinding wheel. It can be recognized that the axes of rotation of cutting wheel S3 and regrinding tool N3 are swiveled in on each other to match the step cut angle α, once for a right-handed and once for a left-handed cutting layout.

FIG. 4 schematically shows a variant in which a cutting wheel S4 not provided with step cut is reground by a rotating cylindrical grinding disk N4. Here you can see how the relative angular location of the respective axes of rotation is set to match a head rake angle of the cutting wheel S4. A grinding stroke movement is indicated by the arrow on both sides. However, it could also be considered, for example, to make a compensation movement in the direction of the cutting wheel axis and to couple this with the grinding stroke. Cylindrical regrinding tools such as N4 could also be used for a step cut, although not in the regrinding position shown in FIG. 4, but in a position rotated at 90° to the cutting wheel axis (which is an interim position between the 0° position close to the skiving head and the 180° position far from the skiving head), possibly with offset.

The schematic representation in FIG. 5 shows a positioning and grinding stroke variant of the machine shown in FIG. 1 or other machines with corresponding movement axes. Here a grinding stroke movement perpendicular to the radial infeed axis X1 of the toothing machine is provided. FIG. 6 then shows how the cup-shaped grinding disk N5 covers almost the entire rake surface 5′. Within the scope of the grinding stroke indicated by the double arrow, the entire rake surface 5′ is reground. Furthermore, the direction of rotation of the regrinding tool N5 is shown. It can be recognized that in the grinding engagement region the rotary grinding movement runs from its direction predominantly radially (with respect to the axis of rotation of the cutting wheel) to the rake surface 5′, with a grinding direction towards the center of the tool.

FIGS. 7 (radial and in the direction of axis X1) and 8 (diagonal) show alternative grinding stroke directions or positionings of regrinding tool to cutting wheel. A rake face 5′ is (still) re-ground, which is in the region of a parallel to the stroke direction H passing through the center of the cutting wheel. Again, the main component of the rotatory grinding movement is 5′ parallel to the radial direction of the rake surface; the grinding direction is according to the preferred shaping towards the center of the tool.

Even in cases where the regrinding tool is clamped onto the machine table (C1), a grinding stroke in different directions, uniaxial (e.g. X1 or Y1) or also superimposed (X1 and Y1), for example diagonally, is conceivable.

FIG. 9 shows a situation in which the cutting wheel S9 has no step cut. Here, regrinding is carried out in a continuous method, in the position represented in FIG. 9, with cutting wheel S9 and a cup-shaped regrinding tool N9. You can see two regions, KB and NKB, where there is an overlap due to this positioning. In the exemplary embodiment shown, however, not both regions KB and NKB are reground, but a grinding contact only exists in region KB, due to a slight inclination of the wheel planes of the cutting wheel S9 and the cup wheel N9. The respective rotational speeds are coordinated with each other in such a way that in the contact area KB grinding grooves are generated, which essentially, in any case with a predominant directional component in relation to the axis of rotation of the tool, run radially on the rake surfaces. Here too, the grinding direction is directed towards the center of the tool.

FIG. 10 schematically illustrates a pick-up solution. A skiving wheel S10 is represented, which cuts a workpiece WS with an internal toothing. The workpiece is clamped on a pick-up spindle P1. A regrinding tool N10 is clamped on another pick-up spindle P2 and is used to regrind the cutting wheel W10. This is done by positioning along the Y axis.

As can be seen from the above, the invention is not limited to the realization as specifically represented in the examples above. Rather, the individual features of the above description as well as the following claims, individually and in combination, can be essential for the realization of the invention in its different embodiments.

1. Method for machining toothings, for which a disk-shaped and toothed tool (5) is used, which is driven rotationally about its axis of rotation and has a geometrically defined cutting edge, the tool teeth (4) of which are made of a base material and are provided with a coating that improves wear resistance at least on the tooth flanks, and also have rake surfaces (5, 5′) facing an end face of the tool, which are reground from time to time in the scope of reconditioning the tool,
characterized in that the use of the tool is resumed and continued after at least one regrinding with regions of the rake surfaces formed in any case along the cutting edges from the base material.

2. Method according to claim 1, in which the continued use takes place on the same toothing machine (100) as the use before regrinding.

3. Method according to claim 1 or 2, in which a machine control for continued use automatically receives information about the depth of removal during resharpening.

4. Method according to claim 1 in which the continued use is carried out without intermediate measurement of a first toothing machined after resumption.

5. Method according to claim 1 in which the regrinding is carried out on a regrinding station coupled via a tool changer with a toothing machine on which the previous or continued use is carried out.

6. Method according to claim 1 in which the regrinding is carried out in the tool clamping of a toothing machine (100) on which the previous and/or continued use takes place.

7. Method according to claim 6, in which the regrinding tool is fed from a direction (Y) tangential to a radial infeed movement (X1) of the toothing machining.

8. Method according to claim 1 in which the rake surface is reground by performing an especially horizontal grinding stroke movement (H).

9. Method according to claim 6 in which a swivel angle (A1) of the tool axis orientation remains unchanged between use in machining and regrinding.

10. Method according to claim 6 in which the tool has a non-zero head rake angle and a swivel angle (A1) for the tool axis orientation is set to the head rake angle for regrinding.

11. Method according to claim 6 in which, before regrinding, a probing of the tool is carried out with the regrinding tool semi-automatically or automatically.

12. (canceled)

13. (canceled)

14. (canceled)

15. (canceled)

16. (canceled)

17. Method according to claim 6 in which at least one machine axis (Y3) actively moving the regrinding tool is used for the relative positioning of the regrinding tool to the tool to be reground.

18. Method according to claim 6 in which at least one machine axis (X1, Y1, Z1) actively moving the tool to be reground is used for relative positioning between the reground tool and the tool.

19. Method according to claim 6 in which predominantly radially extending grinding grooves are produced on the tool and rotary movements of the tool and regrinding tool are matched to one another to produce predominantly radially extending grinding grooves on the tool.

20. Method according to claim 6 in which the tool to be reground and the grinding region of the regrinding tool overlap in two non-contiguous regions (KB, NKB) when viewed in projection on the tool disk plane during regrinding.

21. Method according to claim 20, in which during regrinding, one end face plane of the tool and the grinding plane of the regrinding tool are brought slightly out of parallelism so that the grinding tool has grinding contact only in one (KB) of the non-contiguous regions.

22. Method according to claim 1 for machining toothing, to which a disk-shaped and toothed tool driven in rotation about its axis of rotation and having a geometrically defined cutting edge is used, the tool teeth of which have rake surfaces facing an end face of the tool, which are reground from time to time, the use of the tool being resumed and continued after regrinding, wherein the method is characterized in that resharpening is carried out already on or before reaching a wear mark width of 1.6 mm for PM-HSS tools, and before or on reaching a wear mark width of 0.08 mm for carbide tools.

23. Control program for a toothing machine which, when executed on the machine controller of the toothing machine, controls the toothing machine to perform a process according to claim 1.

24. Toothing machine (100) with a workpiece spindle (C1) for the rotatably drivable bearing of a workpiece carrying a toothing, a tool spindle (B1) for the rotatably driven bearing of a disk-shaped and toothed tool with a geometrically defined cutting edge and with machine axes (X1, Y1, Z1) for the relative positioning of tool and workpiece as well as a machine control for the control of the toothing machining performed with the tool,
characterized in that the machine control has a control program according to claim 23 and/or has movement means (41, 42, 44) which, when actuated, brings a regrinding tool for regrinding the rake surfaces (5) of the tool teeth (4) into grinding engagement with the tool.

25. Toothing machine according to claim 24, in which the moving means have at least one machine axis (Y2, Y3) which can changeably adjust the location or orientation of an axis of rotation of the regrinding tool.
